(19) United States
(12) Patent Application Publication
(10) Pub. No.: US 2014/0248373 A1
(43) Pub. Date: Sep. 4, 2014

(54) ENHANCED PERFORMANCE HYDROGEN PEROXIDE FORMULATIONS COMPRISING PROTEINS AND SURFACTANTS

(71) Applicant: Advanced BioCatalytics Corporation, Irvine, CA (US)

(72) Inventors: Andrew Henry MICHALOW, Irvine, CA (US); Michael G. GOLDFELD, Irvine, CA (US); Carl W. PODELLA, Irvine, CA (US); John W. BALDRIDGE, Irvine, CA (US)

(73) Assignee: Advanced BioCatalytics Corporation, Irvine, CA (US)

(21) Appl. No.: 14/279,352

(22) Filed: May 16, 2014

Related U.S. Application Data
(63) Continuation of application No. 12/581,007, filed on Oct. 16, 2009.
(60) Provisional application No. 61/196,289, filed on Oct. 16, 2008.

(51) Int. Cl. C11D 3/39; C11D 3/32; A01N 59/00

(52) U.S. Cl. CPC C11D 3/3902; A01N 59/00; C11D 3/32
USPC 424/616; 510/375

(57) ABSTRACT

Disclosed herein are compositions comprising: an oxidizing agent; a surfactant; and a protein component. Also disclosed are methods of cleaning a surface, the method comprising applying an aqueous solution to the surface, the solution comprising the above compositions.

### RELATED APPLICATIONS

This application is a continuation of the U.S. application Ser. No. 12/581,007, filed on Oct. 16, 2009, by Michalow et al., and entitled “ENHANCED PERFORMANCE HYDROGEN PEROXIDE FORMULATIONS COMPRISING PROTEINS AND SURFACTANTS,” which in turn claims priority to the U.S. Provisional Application Ser. No. 61/196,289, filed on Oct. 16, 2008, by Michalow et al., and entitled “ENHANCED PERFORMANCE HYDROGEN PEROXIDE FORMULATIONS COMPRISING PROTEINS AND SURFACTANTS,” the entire disclosure of both of which is incorporated by reference herein.

### FIELD OF INVENTION

The present invention is in the field of cleaning agents, and in particular in the field of hydrogen peroxide (H₂O₂) compositions comprising protein/surfactant systems that yield improvement in chemical processes, and where the proteins are derived from a fermentation process.

### SUMMARY OF THE INVENTION

Disclosed herein are compositions comprising: an oxidizing agent; a surfactant; and a protein component. Also disclosed are methods of cleaning a surface, the method comprising applying an aqueous solution to the surface, the solution comprising the above compositions.

### DETAILED DESCRIPTION OF THE EMBODIMENTS

Disclosed herein are compositions comprising an oxidizing agent; a surfactant; and a protein component. In some embodiments, these compositions are used as cleaning agents. In other embodiments, the compositions are used as disinfecting agents.

An “oxidizing agent” is a chemical compound that oxidizes another compound, and itself is reduced. In certain embodiments, the oxidizing agent comprises at least one of the following: a hypohalite ion, a halite ion, a halate ion, a perhalate ion, ozone, oxone, halogen, a peroxide, a superoxide, a peracid, a salt of a peracid, peracetic acid, performic acid, sodium perborate monohydrate, sodium perborate tetrahydrate, hydrogen peroxide urea complex, and Caro's acid, or a combination thereof. Embodiments of the invention include those in which the oxidizing agent comprises a hypohalite ion selected from the group consisting of the hypochlorite ion, the hypobromite ion, and the hypoiodite ion. In other embodiments of the invention, the oxidizing agent comprises a halite ion selected from the group consisting of the chlorite ion, the bromite ion, and the iodite ion. In yet other embodiments of the invention, the oxidizing agent comprises a halate ion selected from the group consisting of the chlorate ion, the bromate ion, and the iodate ion. Certain other embodiments of the invention include those in which the oxidizing agent comprises a perhalate ion selected from the group consisting of the perchlorate ion, the perbromate ion, and the periodate ion.

In some embodiments, the oxidizing agent is a peroxide. Examples of peroxides include hydrogen peroxide (H—O—O—H), an alkyl peroxide (R—O—O—H, where R is an alkyl), a dialkyl peroxide (R—O—O—R′, where R and R′ are alkyl groups), an aryl peroxide (Ar—O—O—H, where Ar is an aryl group), a diaryl peroxide (Ar—O—O—Ar′, where Ar and Ar′ are aryl groups), and an alkylaryl peroxide (Ar—O—O—R, where Ar is an aryl group and R is an alkyl).

In certain embodiments, the oxidizing agent is hydrogen peroxide. In some of these embodiments, the concentration of the hydrogen peroxide in the composition is between 0.001%-0.1%, or the concentration of the hydrogen peroxide in the composition is between 1%-30%, or the concentration of the hydrogen peroxide in the composition is between 15%-30%, or the concentration of the hydrogen peroxide in the composition is between 1%-13%.

The current invention is based on synergies between the fundamental property of hydrogen peroxide (H₂O₂) as a chemical oxidizing agent, and compositions of proteins and surfactants. The proteins are essentially fermentation derived and are formulated with surfactants, hereinafter to be termed the protein/surfactant system. The synergies between the two respective chemical entities are such that their respective methods of action remain the same as when used independent of each other. That is to say that the H₂O₂ oxidation-reduction potential shows no noticeable change by adding the protein/surfactant system. Conversely, tests indicate that the interfacial tension (IFT) and other attributes of the protein/surfactant system are not adversely affected by the addition of H₂O₂, and in some instances the IFT is actually reduced, thus improving on the performance.

The enhancements can be viewed from two perspectives. First, as in any chemical process, two chemical reactants cannot react unless they come into “contact” with each other. The protein/surfactant system, in that way improves the interfacial tension, or wetability, and the ability of H₂O₂ to penetrate to the targeted substrates or contaminants. The H₂O₂ also enhances the protein/surfactant system. For example, the protein/surfactant system has excellent stain removal characteristics, especially when oil based stains are involved. In other instances stains can be oxidized by H₂O₂ that might be less affected by the protein/surfactant system alone. Further, the protein/surfactant system has shown the ability to neutralize odors and the addition of H₂O₂ adds to the odor reduction effect. H₂O₂ is known to be an effective deodorizer.

H₂O₂ is an excellent disinfectant over a broad range of microorganism species. In many applications, however, such as cleaning, biofilms prevent the H₂O₂ from penetrating and destroying the microorganisms. Biofilms can form in crevices and within porous surfaces, including ceramics, wood, etc. Once H₂O₂ is applied it quickly breaks down into water and oxygen and loses further oxidizing capacity. Microorganisms within a biofilm structure are protected against the H₂O₂, and after it is degraded they start to multiply again. The protein/surfactant system, which does not act directly as an anti-microbial, has the unique dual features of penetrating the tiny pores and then uncoupling, namely oxidative phosphorylation, metabolic process of microbes within the biofilm matrix. This leads to, among other things, the reduction of existing biofilms, and prevention of growth of additional biofilms, which are typically based on complex sugars called polysaccharides, and essentially act as nutrients to the microorganisms in the uncoupled mode. The breakdown of the biofilms and the ability of the proteins to break down oils, reduces the amount of nutrients available to microorganisms and therefore reduces their ability to populate. Finally, the degraded biofilm structure then leaves any remaining microorganisms more susceptible to H₂O₂ destruction. In this sense, there is a synergy between the H₂O₂ and the protein/surfactant system for the purpose of improved disinfecting.

In some embodiments, the compositions disclosed herein are used to clean wood to remove stains or reduce fungal or microbal activity in the wood. The reduced interfacial tension of the protein/surfactant component improves peneration of the oxidizing agent into the wood to clean and to destroy the microorganisms that cause wood rot and the like. Chlorine based cleaners are typically used, but these pose hazards to the environment. In addition, when a wooden deck is rinsed when a chlorine-based cleaner, a neutralizer also will need to be used so that any plants adjacent to the deck are not harmed. The compositions disclosed herein are environmentally safe, do not require neutralizers, and do not harm the vegetation and plants around the wooden deck.

Any proteins that are not used up in the cleaning process and get poured down the drains continue to work on resident bacteria populations and act to reduce organic contamination and BOD (Biological Oxygen Demand) levels in the sewer system, with the same uncoupling mechanism. The H₂O₂ becomes degraded rapidly and does not impede the protein/surfactant system in the drains and sewers.

Yet another advantage in the current development was that the H₂O₂ bleaches out the color of the protein/surfactant system, leaving a clear, or barely visible yellow background color depending on the relative amount of H₂O₂ and protein/surfactant solution. The protein mixture is typically colored amber to dark brown, as an outcome of the fermentation process with molasses as a typical nutrient, and its color is dependent on its concentration in a mixture. Another benefit is that the amount of H₂O₂ used to reduce the color is insignificant. Other strong oxidizers, such as hypochlorite, will produce a similar color reduction. Chlorine compounds are undesirable, however, due to their negative environmental impact. And since only a small amount of H₂O₂ can reduce or eliminate the protein solution color, it provides a low cost method of creating a clear or nearly clear product. This can broaden the uses and improves its acceptance when used in consumer cleaning and/or disinfecting products. Finally, the composition can be developed as a concentrate to be diluted in final use, or in a ready-to-use concentration.

The targeted uses of the compositions include virtually any process where H₂O₂ has utility and includes, but is not limited to, hard and soft surface cleaning, sanitizing and disinfection, odor control, industrial processes, bleaching, mildew removal, bioremediation and the like. In the context of the present disclosure, “cleaning” is defined by its most fundamental features, or a combination thereof: the chemical removal, or lifting from a surface, or neutralization, or the oxidation of organic, inorganic and biologically based compounds or entities, that create or lead to: (a) unsanitary conditions, (b) unpleasant aesthetics such as stains and dirt, (c) odors, (d) biofilms, (e) impede or disrupt mechanical, chemical and biochemical processes. For the purposes of this invention “sanitizing” and “disinfecting’ will hereinafter be termed merely disinfecting. The EPA and other regulatory agencies define the difference in the rates of, and degree of microbial kill to distinguish between sanitizing and disinfecting for both food contact and non-food contact surfaces.

The compositions disclosed herein are safer for the user and environmentally benign by minimizing the residual impact. Functionally, in the compositions disclosed herein the protein/surfactant and H₂O₂ bilaterally improve each other's effectiveness and are mutually stable. Further, the compositions as cleaners have multiple functionality, e.g., cleaning, odor removal, disinfection, biofilm control, and combinations thereof, and can perform this broad functionality at pH levels that are moderate, e.g., 3.5 to 9.5. A further embodiment is that the pH levels can at the extreme levels of 1 to 14, for those processes and conditions that require it.

Another embodiment is that the feature of the protein/surfactant system to reduce interfacial tension can enhance the depth and penetration of cleaning and therefore the disinfecting effectiveness of H₂O₂. Another embodiment is the ability to formulate concentrated products that can then be diluted at the point of use, based on the stability of the proteins in high H₂O₂ concentration. A further embodiment is that, once the H₂O₂ is used up, the proteins keep on working in cleaning porous surfaces, drains, sewers and the like, to reduce organic nutrients, and remove and prevent biofilms by acting to uncouple metabolic processes of existing microorganisms. A further embodiment is for bioremediation where the H₂O₂ provides oxygen to a contaminated soil mix to augment the biological breakdown of organic matter. Another embodiment is for off-line cleaning of crossflow membrane systems that are prone to organic and biological fouling. Other embodiments would be for use in medical and dental equipment and devices. Further uses would be for wastewater and sewer treatments. A final embodiment is that the oxidizers, preferably H₂O₂, can reduce or eliminate the inherent brown color of the protein/surfactant solution allowing the development of clear cleaning solutions at low cost and no measurable loss of functionality.

A need exists in the marketplace for effective, multi-purpose, aqueous cleaning products that are capable of disinfecting, while also having minimal environmental impact and minimal residual toxicity. The compositions described herein take advantage of the surprising fact that a protein/surfactant system mixed with hydrogen peroxide (H₂O₂) showed excellent mutual stability and functionality, even after long term storage. In addition, H₂O₂'s oxidizing properties are used in many other applications including stain and odor removal, bleaching, industrial processes, wastewater treatment, soil remediation, and the like.

H₂O₂ is known to be caustic, capable of damaging various materials by chemical action, and is a strong oxidizing agent. Proteins and other organic compounds are susceptible to H₂O₂ oxidization. It is unexpected and counterintuitive that the protein component of the compositions described herein, which are expected to be denatured in H₂O₂, retain their cleaning activities in its presence.

To distinguish the active components of the fermentation product actives of the compositions disclosed herein, we review other fermentation based products. It is known that enzymes, a component of the fermentation mixture of the compositions disclosed herein, are susceptible to hydrogen peroxide degradation. See, for example, U.S. Pat. App. Publ. No. 20050197270, which explains that peroxides damage enzymes by means of oxidizing some of the amino acid residues in the protein. Further, other yeast fermentation products in the marketplace stress the need to avoid contact with caustic or oxidizing agents. U.S. Pat. No. 4,575,457 teaches that at pH above 8 fermentation-derived skin respiratory factor, SRF, darkens in color, suggesting some degradation and further states that the two compounds should be isolated prior to use as per the patent instructions.

In certain embodiments, the protein component of the compositions disclosed herein are derived from the fermentation of yeast. In some embodiments, the fermentation is an aerobic fermentation, while in other embodiments the fermentation is an anaerobic fermentation. In some embodiments, the protein systems disclosed herein are derived from an aerobic fermentation of Saccharomyces cerevisiae, which, when blended with surface active agents or surfactants, enhance multiple chemical functions, at ambient conditions, or during and after exposure to the extreme conditions. The protein systems disclosed herein can also be derived from the fermentation of other yeast species, for example, kluyveromyces marxianus, kluyveromyces lactis, candida utilis, zygosaccharomyces, pichia, or hansanula.

After the aerobic fermentation process a fermentation mixture is obtained, which comprises the fermented yeast cells and the proteins and peptides secreted therefrom. In some embodiments, the fermentation mixture can be subjected to additional stress, such as overheating, starvation, oxidative stress, or mechanical or chemical stress, to obtain a post-fermentation mixture. The post-fermentation stress causes additional proteins to be expressed by the yeast cells and released into the fermentation mixture to form the stress protein mixture. These additional proteins are not normally present during a simple fermentation process. The additional proteins are known as “stress proteins,” and are sometimes referred to as “heat shock proteins”. Once the post-fermentation mixture is centrifuged, the resulting supernatant comprises both the stress proteins and proteins normally obtained during fermentation. The compositions described herein comprise stress proteins.

Several, rather low molecular weight proteins can be produced by Saccharomyces cerevisiae during fermentation as practiced by those familiar in the art. These proteins appear when the yeast cells have been placed under stress conditions during or near the end of the fermentation process. Although referred to as “heat shock proteins,” the stress conditions can occur during periods of very low food to mass concentrations, or as the result of heat shock or pH shock conditions as described in U.S. Pat. No. 6,033,875, Bussineau, et al., incorporated by reference herein in its entirety. In addition, chemical stress, oxidative stress, ultrasonic vibration and other stress conditions can cause the yeast to express the formation of heat shock proteins, more accurately termed, “stress proteins.”

Conditions for the post-fermentation procedures that produce the “heat shock proteins” are described in U.S. patent application Ser. No. 10/837,312, published as U.S. Patent Application Publication No. 2005-0245414, which is incorporated by reference herein. As is clear from the passages in the '414 publication, and the passages below, the regular fermentation steps do not generate heat shock proteins. Steps that generate heat shock proteins are administered after the fermentation step. It is necessary for the generation of heat shock proteins to cause shock to the fermented yeasts. This shock includes, for example, rapid increase in the temperature, rapid change in the pH of the fermentation broth, rapid physical stress, and the like.

As used herein, the term “protein component” refers to a mixture of proteins that includes a number of proteins having a molecular weight of between about 100 and about 450,000 daltons, and most preferably between about 500 and about 50,000 daltons, and which, when combined with one or more surfactants, enhances the surface-active properties of the surfactants. In some embodiments, the protein component comprises a mixture of multiple intracellular proteins and compounds, where at least a portion of the mixture includes yeast polypeptides obtained from fermenting yeast and yeast stress proteins resulting from subjecting a mixture obtained from the yeast fermentation to stress. The “multiple intracellular proteins and compounds” includes proteins, small proteins, polypeptides, protein fragments, and the like, that are not normally expressed by yeast cells during the fermentation process. These proteins and compounds are only expressed when the yeast cells are subjected to stress and shock following the fermentation process.

In a first example, the protein component comprises the supernatant recovered from an aerobic yeast fermentation process. Yeast fermentation processes are generally known to those of skill in the art, and are described, for example, in the chapter entitled “Baker's Yeast Production” in Nagodawithana T. W. and Reed G., Nutritional Requirements of Commercially Important Microorganisms, Esteekay Associates, Milwaukee, Wis., pp 90-112 (1998), which is hereby incorporated by reference. Briefly, the aerobic yeast fermentation process is conducted within a reactor having aeration and agitation mechanisms, such as aeration tubes and/or mechanical agitators. The starting materials (e.g., liquid growth medium, yeast, a sugar or other nutrient source such as molasses, corn syrup, or soy beans, diastatic malt, and other additives) are added to the fermentation reactor and the fermentation is conducted as a batch process.

After fermentation, the fermentation product may be subjected to additional procedures intended to increase the yield of the protein component produced from the process. Several examples of post-fermentation procedures are described in more detail below. Other processes for increasing yield of protein component from the fermentation process may be recognized by those of ordinary skill in the art.

The supernatant is obtained when the fermentation broth is centrifuged and the cellular debris is separated from liquid broth. While in some embodiments, as discussed above, the supernatant of the fermentation process is used in preparing the compositions described herein, in other embodiments, the fermentation broth is used without any processing. Therefore, in these embodiments, the mixture used in preparing the compositions described herein is the fermentation broth containing excreted proteins and polypeptides and cellular debris, and whole yeasts.

Saccharomyces cerevisiae is a preferred yeast starting material, although several other yeast strains may be useful to produce yeast ferment materials used in the compositions and methods described herein. Additional yeast strains that may be used instead of or in addition to Saccharomyces cerevisiae include Kluyveromyces marxianus, Kluyveromyces lactis, Candida utilis (Torula yeast), Zygosaccharomyces, Pichia pastoris, and Hansanula polymorpha, and others known to those skilled in the art.

In the first embodiment, Saccharomyces cerevisiae is grown under aerobic conditions familiar to those skilled in the art, using a sugar, preferably molasses or corn syrup, soy beans, or some other alternative material (generally known to one of skill in the art) as the primary nutrient source. Additional nutrients may include, but are not limited to, diastatic malt, diammonium phosphate, magnesium sulfate, ammonium sulfate zinc sulfate, and ammonia. The yeast is preferably propagated under continuous aeration and agitation between 30 to 35° C. and at a pH of 4.0 to 6.0. The process takes between 10 and 25 hours and ends when the fermentation broth contains between 4 and 8% dry yeast solids, (alternative fermentation procedures may yield up to 15-16% yeast solids), which are then subjected to low food-to-mass stress conditions for 2 to 24 hours. Afterward, the yeast fermentation product is centrifuged to remove the cells, cell walls, and cell fragments. It is worth noting that the yeast cells, cell walls, and cell fragments will also contain a number of useful proteins suitable for inclusion in the protein component described herein.

In an alternative embodiment, the yeast fermentation process is allowed to proceed until the desired level of yeast has been produced. Prior to centrifugation, the yeast in the fermentation product is subjected to heat-stress conditions by increasing the heat to between 40 and 60° C., for 2 to 24 hours, followed by cooling to less than 25° C. The yeast fermentation product is then centrifuged to remove the yeast cell debris and the supernatant, which contains the protein component, is recovered.

In a further alternative embodiment, the fermentation process is allowed to proceed until the desired level of yeast has been produced. Prior to centrifugation, the yeast in the fermentation product is subjected to physical disruption of the yeast cell walls through the use of a French Press, ball mill, high-pressure homogenization, or other mechanical or chemical means familiar to those skilled in the art, to aid the release of intracellular, polypeptides and other intracellular materials. It is preferable to conduct the cell disruption process following a heat shock, pH shock, or autolysis stage. The fermentation product is then centrifuged to remove the yeast cell debris and the supernatant is recovered.

In a still further alternative embodiment, the fermentation process is allowed to proceed until the desired level of yeast has been produced. Following the fermentation process, the yeast cells are separated out by centrifugation. The yeast cells are then partially lysed by adding 2.5% to 10% of a surfactant to the separated yeast cell suspension (10%-20% solids). In order to diminish the protease activity in the yeast cells, 1 mM EDTA is added to the mixture. The cell suspension and surfactants are gently agitated at a temperature of about 25° to about 35° C. for approximately one hour to cause partial lysis of the yeast cells. Cell lysis leads to an increased release of intracellular proteins and other intracellular materials. After the partial lysis, the partially lysed cell suspension is blended back into the ferment and cellular solids are again removed by centrifugation. The supernatant, containing the protein component, is then recovered.

In a still further alternative embodiment, fresh live Saccharomyces cerevisiae is added to a jacketed reaction vessel containing methanol-denatured alcohol. The mixture is gently agitated and heated for two hours at 60° C. The hot slurry is filtered and the filtrate is treated with charcoal and stirred for 1 hour at ambient temperature, and filtered. The alcohol is removed under vacuum and the filtrate is further concentrated to yield an aqueous solution containing the protein component.

The compositions described herein include one or more surfactants at a wide range of concentration levels. Some examples of surfactants that are suitable for use in the detergent compositions described herein include the following:

Anionic: Sodium linear alkylbenzene sulphonate (LABS); sodium lauryl sulphate; sodium lauryl ether sulphates; petroleum sulphonates; linosulphonates; naphthalene sulphonates, branched alkylbenzene sulphonates; linear alkylbenzene sulphonates; alcohol sulphates; PO and/or PO/EO sulfated alcohols.

Cationic: Stearalkonium chloride; benzalkonium chloride; quaternary ammonium compounds; amine compounds.

Non-ionic: Dodecyl dimethylamine oxide; coco diethanol-amide alcohol ethoxylates; linear primary alcohol polyethoxylate; alkylphenol ethoxylates; alcohol ethoxylates;

EO/PO polyol block polymers; polyethylene glycol esters; fatty acid alkanolamides.

Amphoteric: Cocoamphocarboxyglycinate; cocamidopropylbetaine; betaines; imidazolines.

In addition to those listed above, suitable nonionic surfactants include alkanolamides, amine oxides, block polymers, ethoxylated primary and secondary alcohols, ethoxylated alkylphenols, ethoxylated fatty esters, sorbitan derivatives, glycerol esters, propoxylated and ethoxylated fatty acids, alcohols, and alkyl phenols, alkyl glucoside glycol esters, polymeric polysaccharides, sulfates and sulfonates of ethoxylated alkylphenols, and polymeric surfactants. Suitable anionic surfactants include ethoxylated amines and/or amides, sulfosuccinates and derivatives, sulfates of ethoxylated alcohols, sulfates of alcohols, sulfonates and sulfonic acid derivatives, phosphate esters, and polymeric surfactants. Suitable amphoteric surfactants include betaine derivatives. Suitable cationic surfactants—include amine surfactants. Those skilled in the art will recognize that other and further surfactants are potentially useful in the compositions depending on the particular detergent application.

Preferred anionic surfactants used in some detergent compositions include CalFoam® ES 603, a sodium alcohol ether sulfate surfactant manufactured by Pilot Chemicals Co., and Steol® CS 460, a sodium salt of an alkyl ether sulfate manufactured by Stepan Company. Preferred nonionic surfactants include Neodol® 25-7 or Neodol® 25-9, which are C12-C15 linear primary alcohol ethoxylates manufactured by Shell Chemical Co., and Genapol® 26 L-60, which is a C12-C16 natural linear alcohol ethoxylated to 60E C cloud point (approx. 7.3 mol), manufactured by Hoechst Celanese Corp.

Several of the known surfactants are non-petroleum based. For example, several surfactants are derived from naturally occurring sources, such as vegetable sources (coconuts, palm, castor beans, etc.). These naturally derived surfactants may offer additional benefits such as biodegradability.

H₂O₂ and its compositions are used in a wide range of chemical processes. It is one of the most powerful oxidizing agents known and this key property is the basis for its utility. It breaks down into water and oxygen, which makes it desirable as an environmentally friendly chemical. A number of chemical environments can affect the performance of H₂O₂ and the methods and compositions disclosed herein are largely concerned with enhancing the performance of H₂O₂ through the use of surface active agents based on stress protein and surfactant mixtures.

The unique features of each of the two components, H₂O₂ and protein/surfactant systems, when combined, provide a synergistic enhancement of functionality that can replace compositions that are more toxic when using traditional chemistries.

### Dual Purpose Cleaners/Disinfectants

The use of surfactants to enhance H₂O₂ is well known and the method of action is generally stated that the surfactant reduces the surface tension. Work done with protein solutions by the Assignee of the current invention indicated that interfacial tension is a more critical feature in determining cleaning efficiency and the penetration characteristics of aqueous solutions.

Compositions using the proteins of the current patent have the unique feature of reducing interfacial tension, reducing critical micelle concentration and to some degree, reducing surface tension, when combined with surfactants, compared to the properties of the surfactants alone. In addition, the protein based cleaners have exhibited the ability to break down oils and biofilms, where some of the fractions show surface activity that provides an autocatalytic cleaning effect. These features act in concert to allow the H₂O₂ to reach the targeted microorganisms by helping to remove obstructing compounds. See U.S. Patent Application Publication Nos. 20050245414, 20040180411 and 20080167445, all of which are incorporated by reference herein. Further, it is well known to those trained in the art, that H₂O₂ oxidizing efficiency is enhanced with the addition of a surfactant.

The most common purpose of a surfactant is to emulsify or disperse one liquid phase into another—usually an oil phase into water. When two immiscible liquids are in contact, a boundary forms between them. Interfacial tension is a measure of how much work is needed to increase this interface area. Increasing the interface area results in the dispersion of one phase into another as small droplets. The lower the interfacial tension the more one phase is emulsified into the other. So a low interfacial tension is correlated with cleaning efficiency in hard surface cleaning and laundering as well as in other applications.

For institutional and industrial uses, the process of using two cleaning cycles, i.e., one for disinfecting and one for contaminant removal, can significantly add to operational costs. Dual purpose cleaners as disinfectants were developed to simplify the cleaning/disinfecting process. Disinfectant cleaners typically rely on toxic germicidal agents that are based on, but not limited to, phenoles, aldehydes, quaternary ammonium compounds and chlorine compounds. Hospital workers are particularly concerned about removing pathogens, for good reason, and the constant use of such disinfectant cleaners, consequently, may overexpose workers to toxic disinfectants. In addition, pathogens may develop resistance to the disinfecting agents with constant use and creating “superbugs.”

In many other industrial and institutional cleaning processes, it is not necessary to regularly expose workers to such toxic compounds. Hydrogen peroxide has generated much interest as an alternative to toxic germicidal agents. H₂O₂ has a broad spectrum of application as a cidal agent for pathogens that include both gram negative and positive bacteria, fungi, viruses, yeasts and molds.

Since the mechanism of killing microorganisms with H₂O₂ is based on oxidation, microorganisms do not develop the types of immunities as against microcidal agents. In addition, the compositions disclosed herein take advantage of the cleaning efficacy of the protein/surfactant compositions at acidic pH, e.g., about 1 to about 7, which is advantageous for H₂O₂ in terms of simplifying shelf stability and disinfecting performance. It is surprising that the protein/surfactant compositions function effectively at acidic pH. Most surfactant systems are unable to efficiently remove oil based contaminants in acidic environment. However, the compositions disclosed herein function very well in acidic environments, which adds to the stability of the hydrogen peroxide. Acidic environment is any environment having a pH of less than or equal to about 7. By “about” a certain pH it is meant that the actual pH of the composition is ±10% of the stated value.

H₂O₂ is very reactive and therefore stabilization of its reactivity is necessary for ready-to-use and ready-to-dilute industrial, institutional and consumer applications. Generally, as noted in U.S. Pat. No. 5,900,256, which is incorporated by reference herein, H₂O₂ is more stable and its ability to destroy pathogens is more efficient at acidic pH levels. This combination gives a unique, dual purpose H₂O₂ composition for cleaning and disinfecting without the need for solvents to augment removal of oils at acidic pH.

In applications where the oxidizing properties of H₂O₂ are desired to enhance cleaning, stain removal and bleaching, it has typically been necessary to formulate with a pH in the alkaline range. The cleaning aspect is driven by the limitation of traditional surfactant systems, which are more effective in lifting and emulsifying oils and other contaminants at alkaline pH levels. An alkaline pH has been a generally accepted requirement for improved cleaning, especially for the removal of oil based contaminants, as for example, discussed in U.S. Pat. No. 7,169,237 incorporated by reference herein. U.S. Pat. No. 5,069,919, incorporated by reference herein, teaches that bleaching with hydrogen peroxide is optimally done at pH of 8.5 or greater.

Because of the reduced anti-microbial activity at higher pH levels, and the reduced cleaning efficiency of typically used cleaning surfactants in acidic conditions, H₂O₂ compositions have tended to focus on one of the two features. U.S. Pat. Nos. 6,346,279, 6,803,057, 6,479,454, and Patent Application Publication No. 20050058719, all of which are incorporated by reference herein, focus their discussions almost entirely on disinfecting characteristics of H₂O₂ compositions at acidic pH levels. It would have to be presumed that any soiling would have to be cleaned prior to the disinfecting step, in a two-process procedure. U.S. Pat. No. 6,277,805, incorporated by reference herein, further distinguishes between the cleaning efficacy of alkaline versus acidic cleaners, especially with oils.

U.S. Patent Application Publication No. 20050058719, incorporated by reference herein, teaches that a H₂O₂ level of 0.01% can show some level of bacterial reduction. U.S. Pat. No. 5,069,919, incorporated by reference herein, teaches that a H₂O₂ level of 0.1% destroys most bacteria. U.S. Pat. No. 6,479,454, incorporated by reference herein, defines H₂O₂ concentrations as low as 10 ppm. U.S. Pat. No. 5,641,530, incorporated by reference herein, defines H₂O₂ concentrations in the 0.001% to 0.1% for disinfecting foodstuffs. It is clear that disinfecting with H₂O₂ does not necessarily require a high concentration, though generally, the higher the concentration of H₂O₂, the faster the kill time.

In order for any germicidal agent, including H₂O₂, to be effective as a disinfectant it has to be able to come into contact with targeted pathogens. In practical application, however, microorganisms generally thrive, and are protected in natural settings by oils, biofilms, porous substrates, and other environmental enablers. U.S. Patent Application Publication No. 2007/0166398A1, incorporated by reference herein, teaches that organic and inorganic soils reduce activity of anti-microbial agents. Microbes evolved to create biofilms to act as shields, which can protect multiple microorganism species from anti-microbial agents.

One approach to solve the issue of penetrating and removing oil and grease with H₂O₂ cleaner/disinfectants is the use of solvents such as d-limonene and glycol ether solvents. See, for example, U.S. Pat. Nos. 5,602,090 and 6,316,399, incorporated by reference herein (Melikyan patents). D-limonene is a strong solvent and as such, can cause swelling of numerous polymers including rubber materials used in seals such as, Buna-N (a copolymer of butadiene and acrylonitrile), EPDM (ethylene propylene diene Monomer rubber), or Neoprene (polychloroprene). It can degrade many ubiquitous plastics, such as ABS (acrylonitrile butadiene styrene), urethane and Styrofoam. Glycol ethers are another family of solvents that are effective solvents and used in conjunction with H₂O₂. Glycol ethers have toxic attributes though the toxicity varies with the particular glycol ether being used, and can also degrade certain plastic and rubber compounds, which limits their range of use.

In addition to the above, the Melikyan patents disclose the use of sulfonic acid and sulfonate surfactants, both of which are not easily biodegradable. The protein component of the compositions disclosed herein is benign to most polymeric materials, glass, plastic, rubber, and most fabrics, making the H₂O₂/protein/surfactant systems extremely versatile in where they can be used. The proteins are completely biodegradable.

U.S. Pat. No. 6,939,839 (Johnson patent), incorporated by reference herein, also based on H₂O₂/D-limonene, states benefits of using lower levels of surfactants than disclosed in the Melikyan patents but fails to define the comparative amounts in actual use. The Johnson patent relies largely on the same types of sulfonic acid and sulfonate surfactants. Both the Melikyan and Johnson patents choose the preferred glycol ether to be ethylene glycol monobutyl ether, which has known toxicities and has been listed as unacceptable for Green Seal® registration as a safe ingredient for ‘green” cleaning formulations. Both the Johnson and Melikyan patents discuss antimicrobial activity of their d-limonene/H₂O₂ compositions but fail to show data on antimicrobial activity so the dilutions required for disinfection are not known.

In the compositions disclosed herein both the H₂O₂ and protein/surfactants are inherently safe, toxicologically and environmentally benign, and also benign to most materials in concentrations for most uses cited, including ceramics, glass, plastic and rubber compounds, fabrics and carpeting, though the level of H₂O₂ is preferably monitored to prevent bleaching at higher concentrations. More importantly, the protein/surfactant cleaning system has been shown to have higher cleaning efficiency than cleaners based on solvents. See Table 1, below, for a comparison of interfacial tension data against several commercial cleaners. The protein/surfactant compositions are particularly effective at cleaning oils and greases, both synthetic and naturally derived, and these tend to be the most challenging for other surfactant systems, especially when the desire is to formulate with near neutral, or acidic pH conditions. In addition, tenacious stains such as from wine are effectively removed by the protein/surfactant system cleaners.

TABLE 1
Comparison of Interfacial Tension of Protein/Surfactant Cleaner
with Commercially Available Products

| | | | | | Non- |
|---|---|---|---|---|---|
| | Castrol ® | Bacon | Peacock | | Volatile |
| | Motor Oil | Grease | Lard Oil | pH | Solids % |
| Swiffer WetJet ® | 5.67 | 6.32 | 3.40 | 7.4 | 0.05 |
| Formula 409 ® | 4.43 | 5.13 | 1.98 | 11.2 | 1.08 |
| All-Purpose | | | | | |
| Cleaner | | | | | |
| Fantastik ® | 1.45 | 0.99 | 0.77 | 11.8 | 2.20 |
| All-Purp Clnr | | | | | |
| (anti-bact) | | | | | |
| Simple Green ® | 2.07 | 4.25 | 1.30 | 9.0 | 6.45 |
| (Full Strength) | | | | | |
| Composition II, | 1.68 | 0.63 | 1.03 | 6.0 | 0.50 |
| P/S-2 @ 3% | | | | | |

The surfactant system of the compositions disclosed herein can be chosen from a wide range of commercially available surfactants, which means that the H₂O₂/proteins/surfactants formulations can be optimized for functionality and compatibility. In this regard, a large array of suitable surfactants are available for optimization toward specific end uses.

A 1% H₂O₂ solution has been exempted by the EPA for use in removing pathogens from fruits and vegetables. A protein/surfactant composition that complies with FDA food contact guidelines would improve the efficacy of the H₂O₂ disinfecting operation, as noted previously, where surfactant systems improve access of H₂O₂ to the targeted sites.

In many cleaning applications disinfecting is not a goal, such as in stain removal, odor removal and bleaching, including industrial applications. In those instances, the oxidative properties of H₂O₂ combined with the wetting ability and the ability to process hydrocarbons by the protein/surfactant system provide enhanced and synergistic performance over what either component would do alone. This broadens the range of uses of the particular cleaning formulations.

In the paper and pulp industry, hydrogen peroxide bleaching is done generally at alkaline conditions and H₂O₂ levels of around 5%, chemical bleaching. U.S. Pat. No. 4,130,501, incorporated by reference herein, describes that laundry detergent bleach can typically have an H₂O₂ concentration of about 6%, when diluted it provides available oxygen of about 60 ppm.

U.S. Pat. No. 6,566,574, incorporated by reference herein, teaches that killing bacterial spores requires an H₂O₂ concentration of at least 10% to 20%. Before the H₂O₂ can destroy DNA, the spore shell has to be solubilized or softened and surfactants act to do that. The stability and functionality exhibited by the proteins in the compositions disclosed herein and their action on surfactants in terms of improving interfacial tension provide an improvement to the current state of the art in disinfecting contamination caused by spores.

The EPA has approved the use of H₂O₂ formulations for non-food and food crop applications, indoors and outdoors, before and after harvest and food storage facilities. Due to the low toxicity of the protein and appropriate surfactant of the compositions disclosed herein, these compositions provide the basis for these uses.

### Biofilms—Cleaning

The compositions disclosed herein have the ability of the protein component to uncouple metabolic processes once the H₂O₂ is depleted, as the proteins maintain their effectiveness after exposure to H₂O₂. One of the benefits of uncoupling is the enhanced control of, and removal of biofilms. Biofilms are the source of many odors, in particular persistent odors as in public bathrooms, hospital bathrooms, garbage bin areas, drains, sewer lines, and the like, and can also harbor pathogens.

A limitation to the effectiveness of anti-microbial agents, including H₂O₂, in cleaning applications is that biofilms are present in areas that are difficult to penetrate. Further, biofilms are tenacious and traditional compositions require harsh chemicals or solvents to be able to remove them where scrubbing is not possible. These include porous surfaces, such as concrete, grout lines, tile, marble, crevices, carpeting, etc. Most cleaners that might remove such biofilms would require a concentration of the cleaner that would harm the substrate material, be toxic, and in many cases would not be economically viable.

H₂O₂ does not penetrate biofilms or effectively kill microorganisms in such biofilm structures. It is, however, very effective in killing microorganisms on the surface of biofilms. Further, H₂O₂ will dissipate into water and oxygen rather quickly once exposed in a cleaning application. The protein/surfactant system, however, is stable after exposure to H₂O₂ and therefore will continue its functionality after H₂O₂ exposure. This means that the proteins continue the process of uncoupling of microorganisms within biofilms that have not been exposed to H₂O₂, thus helping to break the biofilms down. Uncoupling accelerates nutrient uptake and their breakdown, such that other organic matter is reduced, thereby lowering levels of microorganisms. In subsequent cleaning operations that use the H₂O₂/protein/surfactant composition, and especially when done with regular frequency, it would be presumed that there is an increased susceptibility of new microorganisms due to weakened biofilms.

Microbes are used in commercially available products to continue the removal of nutrients after the completion of the cleaning operation. U.S. Pat. No. 5,863,882, incorporated by reference herein, describes such a feature and in addition, how the microbes continue to work in drain lines once washed into drains. U.S. Pat. No. 6,180,585, incorporated by reference herein, discloses combinations with quaternary ammonium disinfectant (quats), with surfactants and bacterial spores. The spores are designed to germinate and degrade ongoing residues without offensive odors after the quats kill undesirable microorganisms. A key limitation and contrast with the current invention is that the germinated bacteria would not remove biofilms, and by adding bacteria to the environment, would most likely create additional biofilms to harbor other microorganisms, thus having limitations in the ability to remove the source of persistent odors. End users are limited as the addition of bacteria would not be acceptable in food service establishments, hospitals and medical facilities. Further, quats are a disadvantage because when they are used regularly, quats can create bacterial strains that are resistant to its microcidal effects. Finally, quats are toxic, making them less desirable for workers in applications with regular exposure as in institutional cleaning, and add chlorine based organics to the environment.

In general, the disadvantage of microbe based cleaners is that they add microorganisms to the environment, which works against the objective of cleaning and disinfecting, which is to remove microorganisms from the environment. The bacteria based cleaners also do not typically act immediately as there is a time delay for the bacteria to emerge from the spores before they can start to digest odor molecules, and this is a particular disadvantage when trying to remove odors, such as when a pet urinates on a carpet. Finally, and perhaps most importantly, the bacteria products do not have cite ability to remove or control biofilms.

U.S. Pat. No. 7,189,329, incorporated by reference herein, teaches that biocides have been used to control biofilms by combining a biofilm-degrading technique, such as feeding biofilm-degrading enzymes or physical removal of biofilms with the application of a biocide in the process water. This is a process for limited types of industrial systems. The physical removal of biofilms is not possible with porous materials and deep crevices as in ceramics, and the like. The patent supports the argument that biocides alone cannot remove and control biofilms.

Two main advantages of the protein system of the compositions disclosed herein are that, after the H₂O₂ is dissipated, the proteins continue their uncoupling effect on the residual resident microflora and therefore add to the removal and control biofilms. This leads to more sanitary conditions as in floors, etc., and the proteins keep on working in sewer and drain lines as previously described. Second, the proteins do not add microorganisms to the environment making them inherently more sanitary. In fact, the proteins inhibit the ability of the microorganisms to reproduce. This is especially important in hospitals and food establishments where adding non-pathogenic microorganisms have the potential to cross-breed with pathogenic microorganisms, which would only exacerbate infection issues.

In another aspect, disclosed herein are methods of cleaning a surface, where the method comprises applying an aqueous solution to the surface, the solution comprising an oxidizing agent; a surfactant; and a protein component. “Cleaning” in the context of the present disclosure includes the chemical removal, or lifting from a surface, or neutralization, including stains for example, or the oxidation of organic, inorganic and biologically based compounds or entities, that create or lead to a surface that has less stains, less microorganisms per area, or less odor than before the application of the cleaning solution.

In some embodiments, the cleaning combines multiple functions, for example (a) sanitizing in the initial operation, with (b) continued action of the uncoupling agents after being poured into drain system that promote the cleaning of drains and sewers. In other embodiments, the cleaning combines (a) sanitizing in the initial operation, with (b) continued action of the uncoupling agents after being poured into drain system that accelerates the biological breakdown of organic material, essentially starting the wastewater treatment process.

### Odors

The use of H₂O₂ to remove odors by oxidation is well known as noted by countless products that are commercially available that note this feature. The compositions disclosed herein take advantage of this feature and enhance it with the use of the protein/surfactant system.

The protein/surfactant compositions disclosed herein have the capability of removing a wide variety of odors upon immediate application. See, for example, U.S. Patent Application Publication No. 20080167445, incorporated by reference herein. The compositions disclosed herein improve on this by the addition of H₂O₂, which acts synergistically with the protein/surfactant compositions. Neither of the two key components, H₂O₂ or protein/surfactant, diminishes the effects of the other. That is, the H₂O₂ can oxidize malodorous compounds that might not be effectively neutralized by the protein/surfactant system, such as fox and cat urine.

In a synergistic reaction, the compositions disclosed herein allow for a disinfectant product that helps to remove biofilms that further reduces odors, especially persistent ones, by removing their source, the microbial activity within the biofilm structure. Further, as noted above, the uncoupling feature helps to reduce nutrients, which acts to reduce microbial populations, and this features creates the synergies with the H₂O₂ that is actively anti-microbial.

Other odor control compounds rely on film-forming polymers or cyclodextrins. U.S. Pat. No. 7,307,053, incorporated by reference herein, teaches that cyclodextrins have a major disadvantage in that they leave a residue after the solvent or carrier evaporates. This is due to their method of action where the residue left on the treated surfaces acts to trap odor causing molecules, but will at the same time trap stain causing molecules, which leads to re-soiling and is a disadvantage of the cyclodextrin based odor control agent. U.S. Pat. No. 6,987,099, incorporated by reference herein, teaches that cyclodextrin odor control formulations may require the addition of soluble metal salts to complex with certain nitrogen and sulfur containing molecules. The concentration of cyclodextrins can be as high as 20%, and that of the surfactants can be as high as 8%, of the compositions, leading to a potentially high amount of residue. The lower limit is set at about 1% for the combination.

One advantage of the compositions disclosed herein is that no metal salts are required and excellent odor removal is seen on a wide range of sources such as urine, feces, vomit, seafood, rancid food, mercaptans, wastewater treatment, sewers, and the like. Further, the H₂O₂ component dissipates into water and oxygen, leaving no residue. The proteins are readily biodegradable. The surfactants in the diluted, or ready-to-use compositions are generally less than 1%, and are typically under 0.2% of the composition at the use level. This leaves a very small residue, which can be of particular benefit for curtains, furniture, upholstery, floors, clothing, etc. In the compositions disclosed herein, surfactants can be chosen that are not hygroscopic and that will not tend to bind to surfaces. Hygroscopic means water loving and they tend to attract moisture, which consequently attracts more soiling, and this is a problem noted in many cleaners where the cleaned spot on a carpet seems to always get dirty quicker. The surfactants used in the compositions disclosed herein can then be chosen such that they are easily removed when cleaning porous material, such as carpeting.

The compositions disclosed herein have shown a remarkable ability to remove inner shoe odors. There appears to be a residual effect as it takes longer for shoes to become malodorous after treatment with the protein compositions than without any treatment. Shoe odors are caused by microbial action and the effects of the protein compositions on biological processes enhances the effects in shoe applications.

When used as a spray cleaner, the compositions disclosed herein are effective at neutralizing odors immediately, in many instances without the need to mop or wipe, which can be beneficial in applications such as in public bathrooms. Mechanical agitation, however, is helpful when it can be applied. This simplifies the cleaning process for many applications and reduces costs where labor costs are high. A simple process increases the chance for compliance. The excellent wetting and penetration characteristics of the protein compositions lend effectiveness as a simple spray solution.

### Fermentation

There have been numerous attempts in the past to utilize chemicals from fermentation of yeast. The compositions disclosed herein are differentiated from these in subtle, yet critical and relevant, ways. Fermentation of yeast is used for applications including the production of beer, sake and enzymes. The specific processes by which the yeast is fermented to obtain proteins for use in the compositions disclosed herein have been discussed elsewhere, including the above-incorporated U.S. Patent Application Publication Nos. 20050245414, 20040180411 and 20080167445.

Below, the difference in stability, performance, versatility and cost of other fermentation techniques, as compared with the those of the above-incorporated patent applications is discussed. Different fermentation processes, recipes and refinement techniques yield a different supernatant mixture of chemicals that can be used as a basis for further formulation with surfactants, etc. The supernatant from yeast fermentation can yield a mixture of over 4,000 distinct compounds.

U.S. Pat. No. 3,635,797 (Battistoni) describes essentially an anaerobic process, citing the effervescence of the ferment and the length of time for the fermentation process. The process is optimized for the production of the listed enzymes that are described as being responsible for the method of action.

U.S. Pat. Nos. (Dale) 5,820,758 and 5,849,566 and 5,879,928 and 5,885,950 each cite the fermentation process used by Battistoni as being the one used in its compositions. Dale further teaches that the Battistoni product has been found to be unstable and yielded variable results from one batch to another. The language of Dale is vague and this statement could mean one of two things. First, this could suggest that Dale's patent is based on improvements in the stabilization of the enzymes based on Dale's formulation differences than Battistoni. Dale fails to teach what part of its formulation is the basis for the improved stability. Second, it is possible that the “batch” referred to in the statement is the fermentation process. Fermentation is done in batch processes. If that is so, then Dale would presumably have the same inconsistency referred to as Battistoni. Dale states a feature of improved stability in its formulations so it is presumed that the fermentation supernatant is virtually identical.

As a further distinguishing feature from the compositions disclosed herein, Dale states that the use of anionic and cationic surfactants reduces the performance of its compositions. The compositions disclosed herein produce supernatant that is specifically defined by low molecular weight proteins, and the fermentation can be optimized to maximize the yield of these compounds, and that these proteins act synergistically with a wide range of surfactants, including nonionic, anionic, cationic, amphoteric, etc.

The active ingredients in the Dale patents are the same enzymes as Battistoni. This is consistent with the commercial products of Dale which have limited pH functionality and limited stability in oxidizing conditions and temperature, as per their MSDS's, and these limitations would be expected of the enzymes cited by Battistoni. Further, the compositions and methods disclosed herein do not rely on bubble formation as a mechanism of action as in Dale.

U.S. Pat. No. 6,858,212 (Scholz) describes how a peroxide could be used in a yeast culture to stimulate the production of compounds beneficial for skin treatment. The H₂O₂ is not used in the final product, and the levels of H₂O₂ used by Scholz 0.4-14.7 m/M, are much less than the current invention. One embodiment describes heating the aerated ferment to 30° C., which is the low of the “heat shock” used in the compositions disclosed herein.

The preferred embodiment regarding fermentation processes is to use an aerobic process due to the rapid fermentation cycles, which reduces production costs.

### Uncoupling of Biological Processes

Disclosed herein are specialized yeast fermentation products, which contain bio-active products. The bio-active products comprised largely of low molecular weight, stress proteins, when combined with surfactant(s), display the properties of uncoupling agents, i.e. they separate the bacterial biooxidation of nutrients from ATP synthesis necessary to support, at normal rate, the biosynthetic processes in and multi-plication of bacterial cells, while accelerating the biooxidation processes in bacterial cells. The primary goal for these stress proteins is to increase microbial substrate utilization, i.e., nutrient, or contaminant, uptake. The nutrient of most concern is the biofilm and the intent is that biofilm is degraded. Substrate utilization, or nutrient uptake, is increased because the uncoupler shuts off the oxidative phosphorylation (OP) process, which is the most efficient method by which the microorganisms synthesize ATP (adenosine triphosphate), the ultimate form of cellular energy. OP occurs in any or all organisms, which are capable of utilizing oxygen as an electron acceptor, also called aerobic organisms. The process of OP occurs due to the actions of membrane-bound molecules, enzymes, co-enzymes, etc. It involves and requires the transfer of electrons, and protons, down an electron transport chain, which ends in an oxygen molecule acting as the ultimate electron acceptor. The ultimate, indirect, effect of the electron transport chain is the formation of ATP.

With an uncoupler, secondary, less efficient processes are utilized to synthesize ATP, such as substrate level phosphorylation which is an enzymatic mechanism of ATP production. An uncoupler simply uncouples, or, dissociates, the electron transport process from the formation of ATP. In addition, because the uncoupler results in the loss of a proton gradient, there is a continual loss of energy in the form of heat. Therefore, the effect of the uncoupler is two-fold. It results in a dramatic increase in the utilization of substrate, or nutrient uptake. This occurs first because the microorganism is forced to utilize less efficient pathways to produce ATP for general metabolic functions in order to survive. Secondly, there is a continued loss of energy the microorganism needs to continuously add ATP, because of the continual loss of energy, and this replacement ATP is generated by inefficient methods. A further manifestation of the loss of energy is that there is inadequate energy left for the formation of complex proteins that are necessary for the building of polysaccharides, or biofilms, thus preventing the build-up of biofilms. The increase of nutrient uptake is accelerated to the point where existing biofilms become a food source for the microflora, which is the presumed mechanism of removal of biofilms.

Disclosed herein are methods for cleaning substrates by which H₂O₂ retains its performance properties in the presence of proteins, at times showing improvements due to synergies of protein/surfactant action. In other embodiments, the proteins of the compositions disclosed herein show stability and improved functionality in the presence of up to 27% H₂O₂, a strong oxidizing environment.

Fermentation processes used for the generation of proteins used in the compositions disclosed herein are disclosed in the above-incorporated patent applications (See Publication Nos. 20050245414, 20040180411 and 20080167445). In addition, the ratio of fermentation supernatant to surfactant is optimally in the range of 1 to 3, but in instances where emulsion is not important, interfacial tension can be reduced with higher protein (supernatant) ratio relative to the amount of surfactant in the composition. Alternatively, the protein ratio might be much less than 1. The broad range gives the formulator much flexibility in optimizing products for specific end uses.

### H₂O₂ Titrations

The stability of H₂O₂ in the presence of protein/surfactant compositions was studied and the effect of H₂O₂ on the surface activity of the proteins, as measured by interfacial tension, was determined.

The compatibility of H₂O₂ and the protein/surfactant system was assessed using two approaches. First, oxidation-reduction potential (ORP) of H₂O₂ solution was measured by Square Wave Voltammetry (SWVA) before and after addition of the protein/surfactant solution. Second, H₂O₂ concentration was determined over various time periods, up to one year, in the mixtures of hydrogen peroxide and protein/surfactant mixture, by volumetric titration with standardized permanganate solution.

### Materials & Methods

Two sources of H₂O₂ were used:

1—Product name: Baquacil oxidizer, from Arch chemicals Inc (Norwalk Conn.). Product is equal to a solution of 27.5% H₂O₂

2—Hydrogen peroxide topical solution from Kroger (Cincinnati, Ohio) 3% H₂O₂ (stabilized).

The protein/surfactant composition is essentially described in the Publication Nos. 20050245414 and 20040180411.

For H₂O₂ titrations, ca 0.25N potassium permanganate was used.

ORP measurements were conducted using Square Wave Voltammetry (SWVA) in a glove box, in the absence of atmospheric oxygen. Solutions 27% and 15% H₂O₂ with and without addition of 5% protein/surfactant were taken for these experiments.

Titration of H₂O₂ of permanganate was conducted with dark glass 30 ml burette Reaction between KMnO₄ and H₂O₂ in acidic solution proceeds as follows:

5H₂O₂+2KMnO₄+3H₂SO₄→2MnSO₄+K₂SO₄+5O₂+8H₂O

or, as a net ionic equation:

5H₂O₂+2MnO₄⁻+6H⁺→2Mn⁺²+5O₂+8H₂O

The commercial hydrogen peroxide is ca. 30% (27% in the above case), i.e. ca. 270 g/(34 g/mol×1L)=8 mol/L=16 N.

For titration, ca. 25 mL 5 N H₂SO₄ was placed in a 100 mL conic flask, to which a precisely weighed sample of hydrogen peroxide, about 0.2 g, was added.

As titrant, ca. 0.25 N KMnO₄ (precisely weighed ca 7.9 g in 1.00-L volumetric flask) was placed in the 30 mL semi-automatic, dark-glass burette. Permanganate solution has been stored in the dark in the refrigerator. Titration was conducted with vigorous stiffing and the end point of titration determined as the transition from purple to light pink color.

### RESULTS

### ORP Measurements

Measurements with high H₂O₂ (15%, 27%) and concentrated protein/surfactant showed that there was no significant change in the oxidation potential of H₂O₂, as can be seen in Table 3 below. In these experiments. That result is expected, since, from chemical standpoint, we would not anticipate a complex formation between H₂O₂ and protein/surfactant complex, i.e. the chemical identity of H₂O₂ does not change and its potential must stay essentially the same, provided there is no H₂O₂ decomposition.

The following voltamgrams were obtained. The potential as determined by the position of the apex of current wave was about 1.6 V against saturated silver/silver chloride electrode (about 1.8 V NHE). Addition of 5% of protein/surfactant (P/S-I) did not shift the potential to any significant extent. The current in SWVA is usually considered as a measure of concentration of analyte. However, the method is designed for much lower concentrations, in the micromolar range, therefore we do not expect a quantitative correlation between the current and concentration of H₂O₂. Qualitatively, the wave height was somewhat lower for 15% H₂O₂ than 27% H₂O₂. Addition of 5% protein/surfactant reduced the peak down to 78 mA, as compared to about 92 mA for pure H₂O₂.

TABLE 2
Protein/Surfactant Composition I (P/S-1)

| | |
|---|---|
| Protein Mixture | 20.00% |
| Tomadol ® 25-7 | 7.75% |
| Calfoam ® ES-603 | 2.50% |
| Propylene Glycol | 5.00% |
| Sodium Benzoate | 0.30% |
| Water | 64.70% |
| Total | 100.00% |

Tomadol® 25-7 is a surfactant developed by Air Products and Chemicals, Inc. (Allentown, Pa.). It is a nonionic surfactant made from linear C12-15 alcohol with 7.3 moles (average) of ethylene oxide. Tomadol® 25-7 is part of the Tomadol® family of surfactants. Other members of the family, which in some embodiments are useful in the preparation of the compositions disclosed herein, include Tomadol® 23-3, a nonionic surfactant made from linear C12-13 alcohol with 3 moles (average) of ethylene oxide; Tomadol® 23-5, a nonionic surfactant made from linear C12-13 alcohol with 5 moles (average) of ethylene oxide; Tomadol® 23-6.5, a nonionic surfactant made from linear C12-13 alcohol with 6.6 moles (average) of ethylene oxide; Tomadol® 25-12, a nonionic surfactant made from linear C12-15 alcohol with 11.9 moles (average) of ethylene oxide; Tomadol® 25-3, a nonionic surfactant made from linear C12-15 alcohol with 2.8 moles (average) of ethylene oxide; Tomadol® 25-9, a nonionic surfactant made from linear C12-15 alcohol with 8.9 moles (average) of ethylene oxide; Tomadol® 45-13, a nonionic surfactant made from linear C14-15 alcohol with 12.9 moles (average) of ethylene oxide; Tomadol® 45-2.25, a nonionic surfactant made from linear C14-15 alcohol with 2.23 moles (average) of ethylene oxide; Tomadol® 91-2.5 a nonionic surfactant made from linear C9-11 alcohol with 2.7 moles (average) of ethylene oxide; and Tomadol® 91-6 a nonionic surfactant made from linear C9-11 alcohol with 6 moles (average) of ethylene oxide.

Calfoam® ES-603 is a surfactant developed by Pilot Chemical Co. (Cincinnati, Ohio). It is a clear and 60% active solution of sodium lauryl ether sulfate that contains an average of 3 moles of ethylene oxide. It contains ethanol as a solvent.

TABLE 3

| | E, mV vs. Ag/AgCl | Wave Height, I, mA |
|---|---|---|
| H₂O₂, 15% | 1,550 | 85 |
| H₂O₂, 15% + P/S-1, 5% | 1,525 | 78 |
| H₂O₂, 27% | 1,600 | 92 |

### Permanganate Titrations:

All titrations were conducted with 15% H₂O₂. The aliquots of 0.2 g of H₂O₂ contained about 4 milliequivalent of H₂O₂

With 1% and 3% protein/surfactant, no significant shifts in H₂O₂ concentrations were found, either immediately after their addition, or after long-term storage tested up to one year.

The data in Table 5 show that the H₂O₂ does not adversely affect the key interfacial tension (IFT) of the protein/surfactant system. IFT was found to be a consistent, repeatable and useful metric to measure protein/surfactant performance in a range of end uses.

The data in Table 6 show that the protein/surfactant does not affect the stability of hydrogen peroxide solutions over the entire range of concentrations and the one year time durations.

TABLE 4

| Composition II (PS-2) | % |
|---|---|
| Protein Mixture | 20.00% |
| Aerosol ® OT 75E DOSS (75% Active) | 6.00% |
| Tomadol ® 91-2.5 | 6.00% |
| Tomadol ® 91-6 | 6.00% |
| Hexylene Glycol | 7.50% |
| Water | 54.50% |
| Total | 100.00% |

Aerosol OT 75E is a surfactant having the chemical name 1,4-bis(2-ethylhexyl) sodium sulfosuccinate (CAS Registry Number: 577-11-7).

Composition II is added to distilled water along with H₂O₂ in the proportions shown in Table 5, with water added to yield 100%. The H₂O₂ concentration indicated in Table 5 is based on the active level of hydrogen peroxide.

TABLE 5

| | | | | | |
|---|---|---|---|---|---|
| | PS-2, 1% | PS-2, 1% | PS-2, 3% | PS-2, 3% | PS-2, 3% |
| | H₂O₂ 3% | H₂O₂ 3% | H₂O₂ 5% | H₂O₂ 5% | H₂O₂ 13% |
| | July 2007 | July 2008 | July 2007 | July 2008 | July 2008 |
| Test | (mN/m) | (mN/m) | (mN/m) | (mN/m) | (mN/m) |

Initial Interfacial Tensions with Peacock Prime Burning Lard Oil
(about 10 minutes of phase contact)

| | | | | | |
|---|---|---|---|---|---|
| 1 | 2.73 | 2.64 | 2.17 | 2.01 | 1.76 |
| 2 | 2.75 | 2.58 | 2.15 | 2.03 | 1.71 |
| 3 | 2.78 | 2.58 | 2.14 | 2.04 | 1.74 |
| Average | 2.75 | 2.60 | 2.15 | 2.03 | 1.74 |
| Std. Dev. | 0.03 | 0.03 | 0.02 | 0.02 | 0.03 |

After Possible Oxidation Interfacial Tensions with Peacock Prime
Burning Lard Oil
(48 hours of phase contact)

| | | | | | |
|---|---|---|---|---|---|
| 1 | 2.53 | 2.39 | 1.83 | 1.67 | 1.19 |
| 2 | 2.57 | 2.40 | 1.79 | 1.66 | 1.24 |
| 3 | 2.60 | 2.45 | 1.84 | 1.73 | 1.17 |
| Average | 2.57 | 2.41 | 1.82 | 1.69 | 1.20 |
| Std. Dev. | 0.04 | 0.03 | 0.03 | 0.04 | 0.04 |

TABLE 6
H₂O₂—P/S-II samples one year stability

| | |
|---|---|
| 5% H₂O₂ + 5% P/S-2 | 4.82% |
| 5% H₂O₂ + 3% P/S-2 | 5.11 |
| 5% H₂O₂ + 2% P/S-2 | 4.76 |
| 3% H₂O₂ + 3% P/S-2 | 2.98% |
| 3% H₂O₂ + 2% P/S-2 | 2.99 |
| 3% H₂O₂ + 1% P/S-2 | 2.93 |
| 1% H₂O₂ + 3% P/S-2 | 1.07% |
| 1% H₂O₂ + 2% P/S-2 | 1.08 |
| 1% H₂O₂ + 1% P/S-2 | 1.05 |

### Antimicrobial Activity

### Example 1

Antimicrobial tests were run using Composition II-1% PS-2, 3% H₂O₂—against S. aureus and E. Coli. Test methodology was a Suspension Based, Quantitative Time-Kill at 22° C.

The studies were performed in two sets, with 30, 60, and 90 second time points analyzed the first day and 2, 5, and 10 minute time points analyzed the second day. The initial (“time zero”) concentrations were very similar for both sets of tests, so the data is presented below, as one unified series using the “Time Zero” data from the first set.

Composition II-1% PS-2, 3% H₂O₂—completely disinfects, i.e., total kill, of the inoculated liquid for both microorganisms, a 7 log reduction within 5 minutes. Example 1 shows that the ability of H₂O₂ to act as a disinfectant remains intact when formulated with 1% mixture of a protein/surfactant cleaning composition. Notable in the results is the relatively moderate pH of around 5 and low surfactant concentrations (0.165%) to achieve a 7 log bacteria reduction in both gram positive and gram negative pathogens in less than 5 minutes exposure time.

S. aureus Sample (CFU/mL)

| Day 1 | “Time Zero” | 2.48E+07 |
|---|---|---|
| | 30 s | 4.15E+03 |
| | 60 s | 6.00E+02 |
| | 90 s | 2.00E+02 |
| Day 2 | “Time Zero” | 1.10E+07 |
| | 120 s | 1.50E+02 |
| | 5 min | 0 |
| | 10 min | 0 |

E. Coli Sample (CFU/mL)

| | | |
|---|---|---|
| Day 1 | “Time Zero” | 2.95E+07 |
| | 30 s | 1.03E+07 |
| | 60 s | 3.85E+06 |
| | 90 s | 8.90E+05 |
| Day 2 | “Time Zero” | 3.00E+06 |
| | 120 s | 4.55E+04 |
| | 5 min | 0 |
| | 10 min | 0 |

### Example 2

The following tests were run with PS-2 at a 4% concentration (0.72% total surfactant), H₂O₂ at 3% and phosphoric acid at <0.1% to pH 2.9, Versene (EDTA) at 0.1%. Test methodology was Suspension Based, Quantitative Time-Kill at 22° C., but with 5% Horse serum added to show the effects of organic contaminant on antimicrobial activity. A control of 3% H₂O₂ was run in this example.

The control showed the ineffectiveness of a simple, stabilized 3% H₂O₂ solution, as what one might purchase in a pharmacy, as an antimicrobial in the presence of organic contamination, yielding a mere 1 log reduction in both gram negative and gram positive pathogens after exposure time of up to 10 minutes.

However, when 3% H₂O₂ is combined with a 4% cleaning solution of the protein/surfactant system, the antimicrobial activity improves dramatically. 7 log reductions showing a total kill is achieved in under 5 minutes for both gram negative and gram positive pathogens when the protein/surfactant mixture is added to the H₂O₂.

a. Control, 3% H₂O₂
S. aureus Sample (CFU/mL)

| | |
|---|---|
| “Time Zero” | 1.04E+07 |
| 1 min | 1.20E+07 |
| 5 min | 8.80E+06 |
| 10 min | 3.86E+06 |

E. Coli Sample (CFU/mL)

| | |
|---|---|
| ”Time Zero” | 1.99E+07 |
| 1 min | 1.71E+07 |
| 5 min | 6.80E+06 |
| 10 min | 1.36E+06 |

b. 4% PS-2, 3%, H₂O₂, phosphoric acid <0.1% to pH 2.9, Versene 0.1%
S. aureus Sample (CFU/mL)

| | |
|---|---|
| ”Time Zero” | 1.99E+07 |
| 1 min | 1.09E+05 |
| 2 min | 1.13E+04 |
| 5 min | 0.00E+00 |

E. Coli Sample (CFU/mL)

| | |
|---|---|
| ”Time Zero” | 1.73E+07 |
| 1 min | 6.80E+05 |
| 2 min | 4.00E+04 |
| 5 min | 0.00E+00 |

### Example 3

Antimicrobial activity on hard surfaces, soiled with organic contamination (Horse serum), was run on Stainless Steel and Porous Clay coupons, both with 5% Horse serum contaminant added to simulate real life situations, as in a food processing facility. The same disinfectant solution was run as in Example 2 above. The objective of this example was to show that the protein/surfactant system is effective as a dual purpose, hard surface disinfectant and cleaner. Only one pathogen, S. aureus, was tested since the ability of the H₂O₂/protein/surfactant system was shown to be virtually equal in effectiveness, yielding total kill of both gram negative and gram positive pathogens in similar timeframes, in Example 2.

The purpose of this test was to show that the protein/surfactant system kills on hard surfaces and has the ability to penetrate porous surfaces to achieve a minimum kill rate of 6 logs in under ten minutes, which is considered an effective disinfectant in food contact applications.

The results showed a 7 log reduction and total kill in under 10 minutes on a Stainless Steel surface and a 6 log reduction on a Porous Clay coupon. Porous clay with organic contamination poses one of the most difficult challenges for disinfecting as the pathogens are protected inside the tiny clay pores, as well as by the organic contamination and the protein/surfactant system met the minimum regulatory requirements for a disinfectant in food contact applications, in both situations.

S. aureus Sample on Stainless Steel (CFU/mL)

| | |
|---|---|
| ”Time Zero” | 1.76E+07 |
| 1 min | 1.57E+05 |
| 2 min | 5.60E+03 |
| 5 min | 0.00E+00 |

S. aureus Sample on Porous Clay Coupon (CFU/mL)

| | |
|---|---|
| ”Time Zero” | 1.57E+07 |
| 1 min | 8.20E+04 |
| 2 min | 3.60E+03 |
| 5 min | 1.00E+01 |

### Example 4

### Sanitizing-Disinfectant Tests

Tables 7 and 8. The addition of a small amount of benzyl alcohol, i.e., using the formulation described below, does not destabilize the PSC and hydrogen peroxide mixture and enhances killing efficacy showing a 7 log reduction in under 1 minute for both gram negative and gram positive bacteria.

| Formula: 5ABC80-1 | | % |
|---|---|---|
| Tomadol 91-6 | C9-11 w/ 6EO (Ethylene Oxide) | 0.24% |
| Tomadol 91-2.5 | C9-11 w 2.5EO | 0.24 |
| Chemax DOSS 75E | Dioctyl sulfosuccinate 75% | 0.24 |
| Hexylene Glycol | | 0.30 |
| Ferment | Stress Yeast Extract | 0.80 |
| Hydrogen Peroxide | 30% | 1.85 |
| Benzyl Alcohol | | 3.50 |
| Deionized Water | | 92.83 |
| TOTAL | | 100.00% |

TABLE 7
Data Table - Suspension Time-Kill with 5% Soil - S. aureus
5ABC-80-1

| Sample | CFU/mL |
|---|---|
| ”Time Zero” | 9.30E+06 |
| 1 m | <100 |
| 2 m | <100 |
| 5 m | <100 |

TABLE 8
Data Table - Suspension Time-Kill with 5% Soil - E. coli
5ABC-80-1

| Sample | CFU/mL |
|---|---|
| ”Time Zero” | 1.10E+07 |
| 1 m | <100 |
| 2 m | <100 |
| 5 m | <100 |

What is claimed is:

1. A composition comprising: an oxidizing agent; a surfactant; and a protein component, wherein the protein component comprises a mixture of multiple intracellular proteins, at least a portion of the mixture including yeast polypeptides obtained from fermenting yeast and yeast heat shock proteins resulting from subjecting a mixture obtained from the yeast fermentation to heat shock.

2. The composition of claim 1, wherein the oxidizing agent is hydrogen peroxide.

3. The composition of claim 1, wherein the pH of the composition is less than or equal to about 7.

4. The composition of claim 2, wherein the concentration of the hydrogen peroxide in the composition is between 1%-30%.

5. The composition of claim 2, wherein the concentration of the hydrogen peroxide in the composition is between 0.001%-30%.

6. The composition of claim 1, wherein the concentration of the hydrogen peroxide in the composition is between 0.001%-13%.

7. The composition of claim 1, wherein the surfactant is selected from the group consisting of an anionic surfactant, a cationic surfactant, a non-ionic surfactant, and an amphoteric surfactant, or a combination thereof.

8. The composition of claim 7, wherein the surfactant is selected from the group consisting of sodium linear alkylbenzene sulfonate (LABS); sodium lauryl sulfate; a sodium lauryl ether sulfate, a petroleum sulfonate, a branched or linear alkylbenzene sulfonate, an alcohol sulfate, a linear primary alcohol polyethoxylate, an alcohol ethoxylates, an EO/PO polyol block polymer, a polyethylene glycol ester, a fatty acid alkanolamide, CalFoam® ES 603, Aerosol® OT 75E DOSS, Tomadol® 91-2.5, Tomadol® 91-6, and Tomadol® 25-7.

9. The composition of claim 1, wherein the yeast is selected from the group consisting of Saccharomyces cerevisiae, Kluyveromyces marxianus, Kluyveromyces lactis, Candida utilis, Zygosaccharomyces, Pichia pastoris, and Hansanula polymorpha.

10. The composition of claim 1, wherein the protein component comprises a fermentation broth recovered from a yeast fermentation process.

11. A composition comprising:
hydrogen peroxide, wherein the concentration of the hydrogen peroxide in the composition is between 1%-30%;
a surfactant; and
a protein component, wherein the protein component comprises a mixture of multiple intracellular proteins, at least a portion of the mixture including yeast polypeptides obtained from fermenting yeast and yeast heat shock proteins resulting from subjecting a mixture obtained from the yeast fermentation to heat shock.

12. The composition of claim 11, comprising 7.5% Tomadol 25-7, 2.5% Calfoam 603, 20% protein component, and 5% propylene glycol.

13. The composition of claim 11, comprising 20% protein component, 6% Aerosol OT 75E DOSS (75% actives), 6% Tomadol 91-2.56, 6% Tomadol 91-6.0, ≧7.5% hexylene glycol, and between 1-13% stabilized H₂O₂.

14. The composition of claim 11, comprising at least 10% surfactant, and 20% protein component.

15. A method of cleaning a surface, the method comprising applying an aqueous solution to the surface, the solution comprising:
an oxidizing agent;
a surfactant; and
a protein component;
wherein the protein component comprises a mixture of multiple intracellular proteins, at least a portion of the mixture including yeast polypeptides obtained from fermenting yeast and yeast heat shock proteins resulting from subjecting a mixture obtained from the yeast fermentation to heat shock.

16. The method of claim 15, wherein the oxidizing agent is hydrogen peroxide.

17. The composition of claim 15, wherein the surfactant is a combination of two or more surfactants.
